(19) United States
(12) Patent Application Publication
(10) Pub. No.: US 2010/0192903 A1
(43) Pub. Date: Aug. 5, 2010

(54) DEVICE TO IMPROVE THE BURNING INSIDE A FREE COMBUSTION COMPARTMENT

(76) Inventors: Zion Badash, Savyon (IL); Ilan Saady, Hod Hasharon (IL)

Correspondence Address: Pearl Cohen Zedek Latzer, LLP, 1500 Broadway, 12th Floor, New York, NY, 10036, US

(21) Appl. No.: 12/669,707

(22) PCT Filed: Jul. 22, 2008
(86) PCT No.: PCT/IL08/01010

§ 371 Date: Jan. 19, 2010

(30) Foreign Application Priority Data
Jul. 22, 2007 (IL) 184753

(51) Int. Cl. F02B 77/04

(52) U.S. Cl. 123/198 R

(57) ABSTRACT

The present invention provides an air supply assembly for providing air to an energy heat converter, the air supply assembly comprising an air inlet opening; an air outlet opening; and a metal element positioned in an air flow path between the air inlet opening and air outlet opening, wherein, when air which flowed through the metal element is used for combustion in the energy converter, the thermal efficiency of the energy converter increases, the fuel consumption of the energy converter is reduced and/or the air pollution created by the energy converter is reduced. The present invention also provides a method for reducing fuel consumption of an energy converter and a method for reducing air pollution created by an energy converter, the method comprising passing air through a metal element and using the air for combustion in the energy converter.

### BACKGROUND OF THE INVENTION

Energy converters operating with combustion stage are known for a very long time. Efforts were made along the time to improve the efficiency of conversion of the energy in the fuel to thermal and/or mechanical energy, as well as to reduce the amount of pollution produced during their operation. Despite great progress that was made along the years, the efficiency of conversion and the amount of pollution still need improvement. An energy converter using combustion may, schematically, comprise several main units, as depicted in FIG. 1, which is schematic illustration of an energy converter using combustion. Air may be supplied via air supply unit 12; fuel may be supplied via fuel supply unit 14. The air and fuel may be introduced to each other, such as being mixed, in a fuel-air supply unit 16 and may be supplied to power unit 18, where the fuel and air are ignited or otherwise caused to bum and thus transform the inherent energy into thermal and/or mechanical energy, which may be outputted from the energy converter to any desired thermal and/or mechanical consumer. Additionally, exhaust gases are outputted from the converter.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of an energy converter system;

FIG. 2 is a schematic block diagram illustration of an energy converter system according to some embodiments of the present invention;

FIG. 3 is a schematic illustration of an opened position of air supply assembly for supplying air for energy conversion in an energy converter according to some embodiments of the present invention;

FIGS. 4A and 4B are exemplary schematic illustrations of a metal element which may be included in air supply assembly according to embodiments of the present invention; and

FIG. 5 is a schematic flow diagram illustrating the method of operation of an energy converter for reducing air pollution created by the converter and/or reducing fuel consumption of the converter according to some embodiments of the present invention.

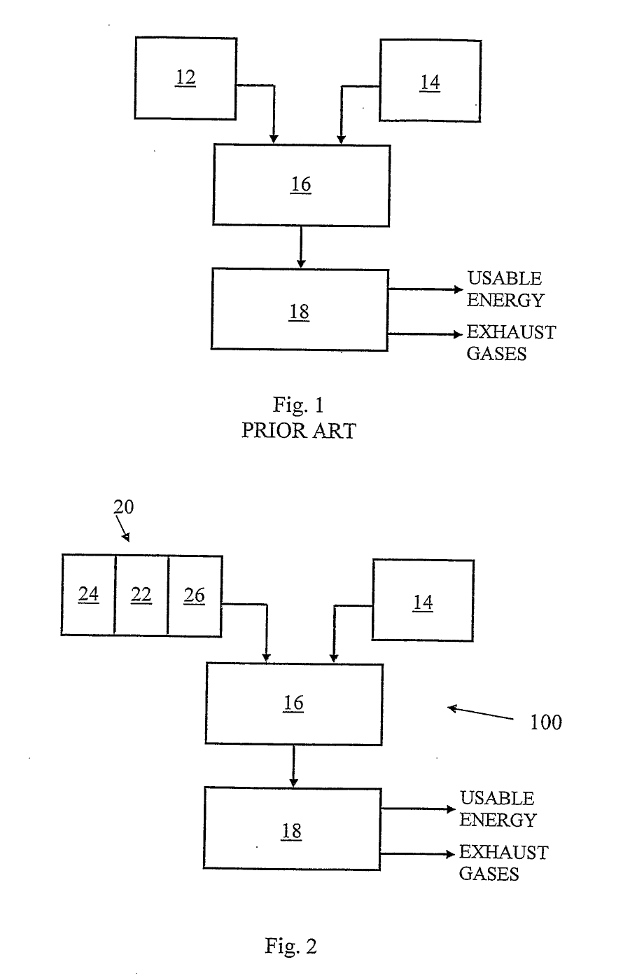

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The inventors of the present invention have found, during research of new systems and methods for improved operation of energy conversion, that by placing a metal element in the course of air into the combustion engine so that the air flows over the material of the metal element, the efficiency of the energy conversion of the energy in fuel into thermal and/or mechanical energy and the output power and/or heat provided by the converter are dramatically increased while the amount of pollution exhausted from the converter is dramatically reduced.

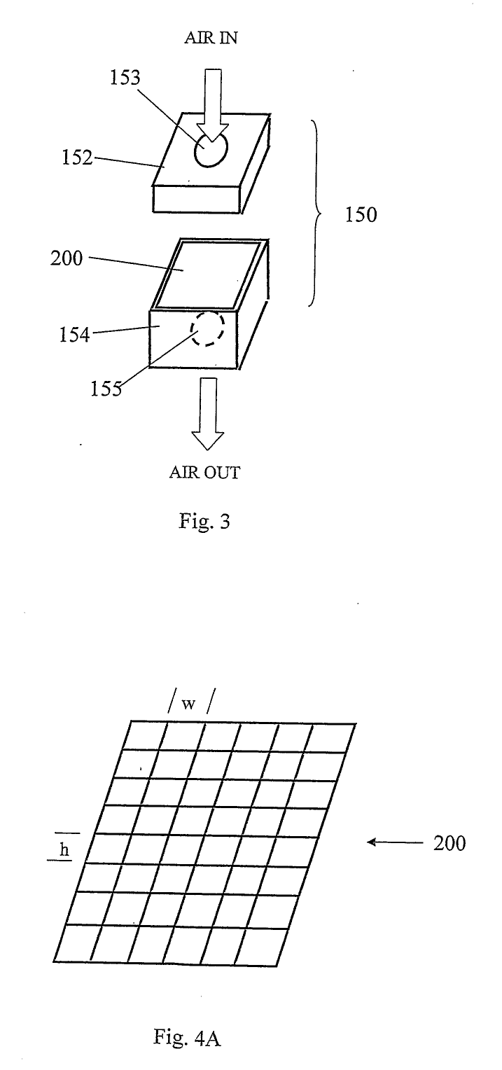

Metal element 200 (shown in FIG. 3) or its equivalent replacement may be made of various kinds of metals, such as copper, with or without thin coating of other material such as silver, gold and the like. Reference is made now to FIG. 2, which is a schematic block diagram illustration of an energy conversion system 100 according to some embodiments of the present invention. Energy conversion system 100 may comprise air supply assembly 20, fuel supply unit 14 and a fuel-air supply unit 16 which may receive the air and the fuel in order to introduce them to each other and to provide an air-fuel supply to conversion unit 18. Air supply assembly 20 may comprise air inlet portion 24, air outlet portion 26 and metal element 22. Metal element 22 may be positioned in an air flow path between air inlet portion 24 and air outlet portion 26. Air inlet portion 24 and/or air outlet portion 26 may include an air duct, an air duct with air filter, or the like. Metal element 22 may include, for example, a metal mesh and/or metal wires and/or metal layers and/or metal lamellas, so that air may flow over and/or pass through portions of metal element 22.

Fuel supply unit 14 may be a fuel tank with or without a fuel pump and/or with or without fuel flow regulator, or the like. Fuel-air supply unit 16 may be, for example, a carburetor, an air-fuel atomizer, a heat regulator and the like. Air may flow and/or pass through and/or over air supply assembly 20 into fuel-air supply unit 16. Fuel-air supply unit 16 may mix and/or introduce to each other air and fuel which may be received, for example, from air supply assembly 20 and fuel supply unit 14, respectively. Fuel-air supply unit 16 may provide the mixture of air and fuel to conversion unit 18, which may be, according to some embodiments, an open combustion chamber, a furnace, an oven and the like. Conversion unit 18 may use the supply of air and fuel for producing mechanical and/or thermal energy, for example, by combustion of the supplied air and fuel or by means of fire. The produced energy may be, for example, thermal energy and/or mechanical power for, for example, vehicles, furnaces and the like. As a result of the energy conversion process a polluting gas, e.g., exhaust gas may be discharged from energy conversion system 100 to the environment. When air which flowed and/or passed through and/or over metal element 22 according to embodiments of the invention, is mixed with or introduced to fuel by fuel-air supply unit 16 and used for energy conversion by conversion unit 18, e.g., in a combustion process, the pollution level of the exhausted gas may be reduced. In addition, conversion unit 18 may need less fuel in order to produce the same amount of converted energy, e.g., the fuel efficiency may be increased and the consumption may be reduced.

Reference is now made to FIG. 3, which is a schematic illustration of air supply assembly 150 of an energy conversion system, including a metal element 200, according to some embodiments of the present invention. Air supply assembly 150 is drawn in “opened” position for the clarity of the illustration. Typically, air supply assembly 150 may be closed so that metal element 200 is enclosed within the assembly. Air supply assembly 150 may comprise an inlet portion 152 with air inlet opening 153 and an air outlet portion 154 with air outlet 155. Metal element 200 made and installed according to embodiments of the present invention may be positioned in air supply assembly 150 as shown in FIG. 3 so that the air flowing and/or passing through air supply assembly 150 may flow substantially perpendicularly through metal element 200. It should be apparent to a person skilled in the art that metal element 200 may be placed in the air flow route in one or more of many different manners and different angles and locations with respect to the direction of the air-flow. Metal element 200 may include a metal mesh and/or metal wires and/or metal layers and/or metal lamellas in any suitable arrangement, so that air may flow over and/or pass through metal element 200. For example, metal element 200 may include one or more thin plates properly placed in the air-flow route and substantially parallel to the air-flow direction so that its surface is exposed to the flow of the air with minimal disturbances to the air-flow.

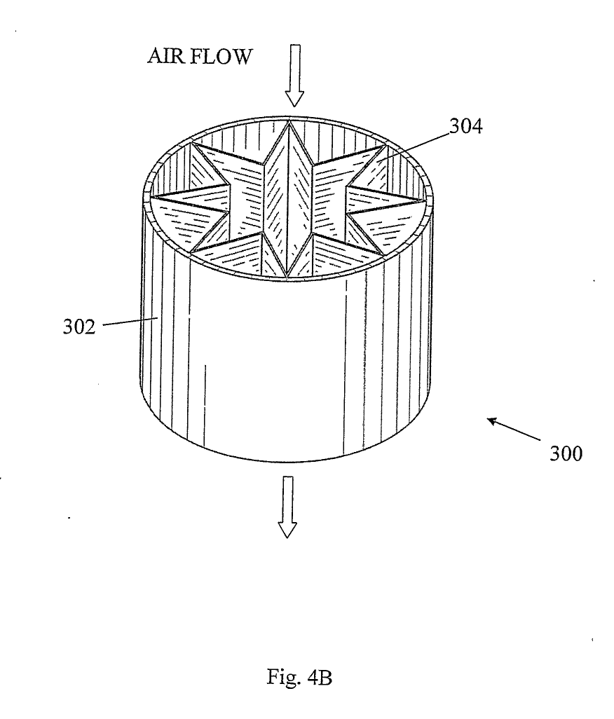

Reference is now made to FIGS. 4A and 4B, which are exemplary schematic illustrations of two possible embodiments of metal elements 200 and 300 respectively, in details. Although the invention is not limited to this example, metal element 200 may be a mesh made from crisscrossed metal wires as shown in FIG. 4A, forming between them a general form of a rectangular with a first dimension “h” and a second dimension “w”. The first and second dimensions “h” and “w” may be, in some cases equal, forming square spaces between the wires. It should be noted that the form of the spaces between the wires may be of any desired form, such as hexagon, heptagon, octagon, circle and the like. Subsequently, the form of the mesh forming these spaces may be any, as long as a negligible interrupt to the flow of air is caused and a substantially high amount of flowing air is exposed to contact with the metal mesh of metal element 200. Thus, the metal elements 200 of FIGS. 3 and 4 are only schematic and for the purpose of example. In yet another embodiment of the invention metal element may be as element 300 of FIG. 4B, comprising a tubular external body 302 and a shaped multi-facets air conduit 304. External body 302 may be omitted in other embodiments of the invention. The number of facets of air conduit 304 and their specific form, may vary as may be required and/or desired, as long as the interrupt of air conduit 304 to the air flow over it is insubstantial and a large amount of air flowing over it is exposed to the option to touch air conduit 304. It should be apparent to one skilled in the art that element 300 may have various shapes and sizes and yet remain in the scope of the invention.

Metal elements 200, 300 may be made of various materials or combinations of materials. Metal elements 200, 300 may include, for example, solid copper, solid copper laminated with gold with thickness of, for example, 80 micrometers, solid copper with presence of solid bulk of gold, copper coated with tin layer of solver and/or palladium and/or platinum or all the above mentioned in other physical forms similar to mesh.

The inventors of the present invention have discovered that when a metal element is inserted into the air flow path of an energy conversion system 100, so that the air consumed by the energy conversion unit flows over and/or passes through the metal element, the performance of the energy conversion unit 18, with respect to efficiency of conversion of the chemical internal energy stored in the fuel to, for example, thermal energy grows higher and the amount of polluted gases in the exhausted gases grows much lower when certain metal, or combination of certain metals are used to construct metal elements 200, 300. The performance of an energy conversion unit 18 according to embodiments of the present invention was measured in different conditions as regarding and as reflected in the operation of various furnaces and heaters. The parameters which were measured include average fuel consumption. The measured results of the performance of various types of energy conversion systems 100 according to some embodiments of the present invention are exemplified in Table 1 below.

Reference is made now to table 1, which presents the results of an experiment done by the inventors of the present invention. Table 1 compares, for given heating systems, heating performance, the content of over-all pollution particles the hue of polluted gases, the content of SO₂, of NOₓ and of CO in exhaust gases of the given furnaces, all these with and without metal element 200 of air supply assembly 20, according to embodiments of the invention. Table 1 illustrates the improvements in these parameters when metal element 200, 300 is installed in an energy converter. Table 1 presents the measured results for heaters described in the right-most column. For each of the furnaces the type of working fuel is indicated and then the above described types of measured variables, in pairs—on the right results as received when the respective furnace worked without (w/o) metal element 200, 300 and to the left of each such column the results measured when that furnace operated with metal element 200, 300 under substantially the same conditions. For condo heaters A, B, C and D SO₂, NOₓ and CO were not measured.

The heating performance of the furnaces was measured as an average of the time required to heat a device to a required temperature, with and without metal element 200, 300 over periods of time of 1 to 10 hours across the various furnaces that were measured. Other performance parameters of the furnaces were measured using a measuring tool made of Ohler, type A500 called Combustion and Emission Analyzer which is adapted to measure carbon monoxide (CO) at a 1 ppm resolution +/−5% accuracy; carbon dioxide (CO₂); SO₂ with resolution of 1 ppm, and NO with resolution of 1 ppm. Table 1 describes the results of conversion of fuel and air mixtures into heat in 16 different furnaces built to heat. As may be seen in Table 1, in substantially all parameters for all types of furnaces there was improvement in performance, varying from over 10% in the lower results to over 65% and above in some of the higher results.

It should be noted that the performance presented in Table 1 reflects results achieved using a metal mesh that was installed in the air inlet assembly or close to it, having the outer dimensions of substantially the cross section of the air filter compartment substantially perpendicular to the air flow direction, as depicted in FIG. 3.

TABLE 1

| | | | | | | Carbon color | | Pollution | | Time to target | | | |
|---|---|---|---|---|---|---|---|---|---|---|---|---|---|
| | | | | | | in exhaust | | particles | | temperature | | | |
| CO | | NOₓ | | SO₂ | SO₂ | gas | | [mg/m3] | | [hours] | | | |
| With | w/o | With | w/o | With | w/o | Color | Color | With the | w/o the | With the | w/o the | Fuel | Description |
| [mg/m³] | [mg/m³] | [mg/m³] | [mg/m³] | [mg/m³] | [mg/m³] | with | w/o | invention | invention | invention | invention | type | of converter |
| 4 | 5.1 | 398 | 670 | 1558 | 3236 | clear | dark | 45 | 110 | 4.1 | 8.3 | diesel | Sauna A |
| | | | | | | | | | | | | | heater |
| | | | | | | | | | | | | | No. 1 |
| 4 | 5 | 408 | 652 | 1568 | 3256 | clear | dark | 44 | 111 | 4.15 | 8.35 | diesel | Sauna A |
| | | | | | | | | | | | | | heater |
| | | | | | | | | | | | | | No. 2 |
| 3.7 | 4.8 | 360 | 367 | 176 | 264 | clear | dark | 38 | 66 | 2.66 | 4.5 | diesel | Sauna B |
| 2 | 3.5 | 404 | 457 | 987 | 1700 | clear | dark | 44 | 51 | 5 | 6 | diesel | Sauna C |
| 1.4 | 2 | 470 | 589 | 231 | 418 | clear | dark | 60 | 101 | 4.33 | 6.2 | diesel | Sauna D |
| 2 | 3.8 | 400 | 466 | 77 | 109 | clear | dark | 67 | 94 | 4.6 | 7.8 | diesel | Sauna E |
| 3 | 4.3 | 325 | 382 | 348 | 466 | clear | dark | 42 | 66 | 0.8 | 1.5 | diesel | Bakery A |
| 2.6 | 3.9 | 400 | 480 | 280 | 300 | clear | dark | 165 | 403 | 1.4 | 2.1 | diesel | Bakery B |
| 3 | 4 | 252 | 288 | 56 | 60 | clear | dark | 289 | 334 | 1.3 | 1.5 | diesel | Bakery C |
| 4.2 | 4.7 | 483 | 523 | 57 | 176 | clear | dark | 188 | 227 | 2 | 2.4 | diesel | Bakery D |
| 1.8 | 3.3 | 298 | 347 | 1766 | 2374 | clear | dark | 46 | 55 | 2.4 | 3 | diesel | Bakery E |
| 2.3 | 2.7 | 501 | 580 | 318 | 462 | clear | dark | 98 | 289 | 0.7 | 1.65 | diesel | Bakery F |
| | | | | | | clear | dark | 66 | 154 | 4.5 | 6 | diesel | Condo A |
| | | | | | | | | | | | | | heater |
| | | | | | | clear | dark | 58 | 90 | 4.8 | 6 | diesel | Condo B |
| | | | | | | | | | | | | | heater |
| | | | | | | clear | dark | 54 | 60 | 6.4 | 7 | diesel | Condo C |
| | | | | | | | | | | | | | heater |
| | | | | | | clear | dark | 55 | 112 | 6.8 | 8 | diesel | Condo D |
| | | | | | | | | | | | | | heater |

From the various types of furnaces and for the various types of test parameters it is clearly shown that the efficiency of the production of thermal energy in the various furnaces if improved from about 10% to about 50%. The overall pollution, as measured in milligrams of polluting particles per cubic meter of exhaust gases has improved in the range of about 20% to about 66% and the specific pollution, as measured for SO2/SO3, NOₓ and CO are mostly in the range of 10% to 50% of improvement that is reduction when a system according to embodiments of the invention is used (“with”).

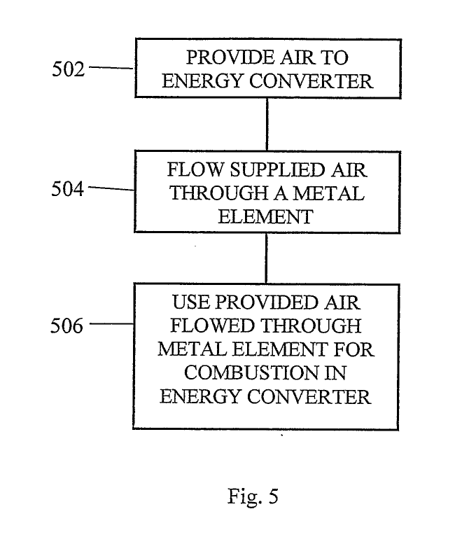

Reference is now made to FIG. 5, which is a schematic flow diagram illustrating a method of operation of an energy conversion system for reducing air pollution created by the combustion engine and/or reducing fuel consumption of the combustion engine according to embodiments of the present invention. Air may be provided to an internal combustion engine is provided to an energy conversion system working according to embodiments of the present invention (block 502). The provided air may be forced to flow over and/or pass thorough a metal element (block 504) and thus to come in contact with the outer surface of the metal element. The air that was flowed through the metal element is then used for combustion in the energy conversion unit (block 506).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An air supply assembly for providing air to an energy conversion unit, said air supply assembly comprising:
an air inlet opening;
an air outlet opening; and
a metal element positioned in an air flow path between said air inlet opening and air outlet opening,
wherein, when air which flowed through said metal element is used for combustion in said an energy conversion unit, the fuel consumption of said combustion engine is reduced.

2. An assembly according to claim 1, wherein the air pollution created by said an energy conversion unit is reduced.

3. An assembly according to claim 1, wherein said metal element comprises copper.

4. An assembly according to claim 1, wherein said metal element comprises at least one of a metal mesh and a metal multi-facets metal conduit.

5. An assembly according to claim 1, wherein said metal element comprises gold lamination.

6. An assembly according to claim 1, wherein said metal element comprises metal wires.

7. An assembly according to claim 1, wherein said metal element comprises metal layers allowing the air to flow over at least some of said layers.

8. An assembly according to claim 1, wherein said metal element comprises a perforated plate.

9. An assembly according to claim 1, wherein air which flows through said metal element drifts oxygen molecules from the surface of said metal element.

10. An assembly according to claim 1, wherein said reduction in fuel consumption ranges from approximately 10% to approximately 50% in time to reach a target temperature.

11. An air supply assembly for providing air to an energy conversion unit, said air supply assembly comprising:
an air inlet opening;
an air outlet opening; and
a metal element positioned in an air flow path between said air inlet opening and air outlet opening, wherein, when air which flowed through said metal element is used for combustion in said combustion engine, the air pollution created by said combustion engine is reduced.

12. An assembly according to claim 11, wherein the fuel consumption of said energy conversion unit is reduced.

13. An assembly according to claim 11, wherein said metal element comprises at least one of copper, silver, gold, palladium and platinum.

14. An assembly according to claim 11, wherein said metal element comprises at least one of metal mesh and multi-facets metal conduit.

15. A method for reducing fuel consumption of an energy conversion unit, the method comprising:
passing air through a metal element; and
using said air for combustion in said energy conversion unit.

16. A method according to claim 15, wherein the air pollution created by said combustion engine is reduced.

17. A method according to claim 15, wherein said metal element comprises at least one of copper, silver, gold, palladium and platinum.

18. A method according to claim 15, wherein said metal element comprises at least one of metal mesh and multi-facets metal conduit.
